(19) United States
(12) Patent Application Publication
(10) Pub. No.: US 2022/0391987 A1
(43) Pub. Date: Dec. 8, 2022

(54) BLOCKCHAIN-BASED INSURANCE CLAIMS TRANSACTION PROCESSING SYSTEM AND METHOD

(71) Applicant: Anthony Allogia, Jupiter, FL (US)

(72) Inventor: Anthony Allogia, Jupiter, FL (US)

(21) Appl. No.: 17/400,951

(22) Filed: Aug. 12, 2021

Related U.S. Application Data
(60) Provisional application No. 63/208,355, filed on Jun. 8, 2021.

(51) Int. Cl. G06Q 40/08; G06Q 20/40

(52) U.S. Cl. CPC G06Q 40/08; G06Q 20/401

(57) ABSTRACT

A blockchain-based system and method that provides for blockchain-based insurance claims transaction processing that improves upon the processing of insurance claims and policies using blockchains and cryptocurrencies for various forms of payments. As such, users (e.g., insured parties and insurance providers) may submit, process, review, approve, decline, issue payments and/or electronically process insurance claim transactions in a fully secure fashion and in compliance with applicable and governing insurance policies. The transactions in each processing step are executed via a blockchain-based insurance claims transaction system employing at least one smart contract thereon and are stored by a corresponding user device into a blockchain whereby the blockchain is updated at each step by the corresponding user device, and the blockchain is stored on each of the corresponding user devices.

### CROSS REFERENCE TO RELATED APPLICATION

This application claims the benefit of U.S. Provisional Application 63/208,355, filed Jun. 8, 2021, which is hereby incorporated by reference herein in its entirety.

### FIELD OF THE INVENTION

The present invention relates generally to insurance systems, and more particularly, to a system and method that facilitate the processing of insurance claims and policies using blockchains and cryptocurrencies.

### BACKGROUND OF THE INVENTION

Individuals, corporations, and governmental bodies all obtain and need insurance to protect against risks, losses and deleterious events that may cause financial ruin. There exists all types of insurance policies from automobile, homeowners, renters, life, business owner, general liability, workers compensation, crime, cyber threats, and property, to name just a few. Of course, from time-to-time events occur that require the policyholder to file a claim under their respective insurance policy with the insurance provider. An insurance claim is a formal written request (e.g, a notice to file claim) by a policyholder to an insurance provider for coverage and/or compensation for a covered loss or policy event. The insurance provider validates the claim or denies the claim, after review. If it is approved, the insurance provider will issue payment to the insured or an approved interested party on behalf of the insured. Insurance claims cover everything from death benefits on life insurance policies to routine and comprehensive medical exams. In some cases, a third-party is able to file claim(s) on behalf of the insured person. However, in the majority of cases, only the person(s) listed on the policy is entitled to claim payments.

Of course, as will be appreciated insurance policies comprise complex legal agreements that specify items to be afforded coverage with respect to particular perils. Numerous conditions typically apply including applicable deductibles, coverage limits, and so forth. Modern insurance policies also often include expense/billing information that breaks down the total cost of the agreement into elements by covered item and peril. Insurance carriers often view such policies as being derived from and related to a “policy product”. A policy product defines the attributes and shared data for its derived policies. The process of writing a specific policy involves referring to the available attributes of the policy as defined by the policy product and the corresponding selection of appropriate values for a given customer. For example, when writing a commercial package policy, the insurer will typically refer to a commercial package policy product to ascertain that such a policy contains coverage with respect to general liability, commercial property, and other more specialized kinds of coverage. The insurer then uses this information to facilitate capture of additional information to fully define the policy and price the insurance coverage offered thereunder. Insurance policies are typically defined at various levels of granularity with a collection of coverages typically comprising a most basic level of resolution through higher resolution levels. The insurance coverage comprises an obligation to pay for damages that are caused by a particular peril (or collection of perils). The obligation typically has corresponding financial limits and deductibles that circumscribe the insurer's responsibility for losses against that coverage. A policy's total cost is usually determined as a function of the aggregate cost of the policy's constituent coverages.

As such, filing an insurance claim can be a complicated and somewhat confusing process. There is typically no one-size-fits-all outcome, and how your insurance claim is handled largely depends on the written provisions in the applicable insurance policy In most cases, the filing of claim involves communicating with your insurance provider, organizing, and completing the required paperwork, completion of a damage appraisal by an adjuster, paying any applicable deductible and a final disposition of the claim (i.e., settlement or denial). This can be a very time consuming and extended over a long time period. When a claim is settled the insured party typically receives, among other things, a monetary award. In today's electronic commerce world there is an increasing focus on the use of digital currencies in replacement of the typically employed fiat currencies to pay insurance settlements.

Digital currency is a currency form that is available in electronic or digital form, but not in physical form. Digital currencies exist and are only accessible with electronic devices, for example, computers and smartphones. That is, digital currencies are intangible and are owned and transacted by using computers or electronic wallets that have access to the Internet or specifically designated computer networks. Digital currencies have all the intrinsic properties of physical currency (e.g., banknotes or minted coins) and allow for instantaneous transactions that are seamlessly executed for making payments across borders and geographic boundaries when the parties are interconnected to supported hardware devices and networks. Today, a number of digital currency variants, regulated or unregulated, exist such as cryptocurrencies and virtual currencies. A cryptocurrency is another form of digital currency that uses cryptography to secure and verify transactions and to manage and control the creation of new currency units. Currently, cryptocurrencies are unregulated so they may also be considered so-called virtual currencies. That is, virtual currencies are an unregulated digital currency that is controlled by its developers, a founding organization, or a defined network protocol.

For instance, Bitcoin is a digital currency created in 2009 that offers the promise of lower transaction fees than traditional online payment forms and is operated by a decentralized authority in distinction from government-issued currencies, for example. There are no physical Bitcoins only public ledger balances that everyone has transparent access to that are verified by computer networks in the context of Bitcoin transactions. Bitcoins are not issued or backed by any banks or governments nor are individual. Bitcoins valuable as a commodity themselves. They are not legal tender in the traditional sense, but their popularity has been on a recent rise. To buy Bitcoin, a person will download a Bitcoin digital wallet that will store the person's Bitcoins for future spending or trading. Bitcoin balances, given Bitcoin is not really a “coin”, are maintained using public and private keys that are long number strings and letters linked through mathematical encryption algorithms. A public key is the location where transactions are deposited to and withdrawn from, and the public key appears in a blockchain ledger as a users digital signature. A private key is the password required to buy, sell, and trade Bitcoin in the Bitcoin wallet. In the U.S., the Securities and Exchange Commission requires users to verify their identities (e.g., using a driver's license or social security number) when registering their digital wallets in an effort to promote anti-money laundering policies. Once established, the digital wallet can used like any other traditional payment method such as a credit card or debit card to buy Bitcoins on a Bitcoin exchange. Once purchased, the Bitcoins are transferred to the buyer's digital wallet.

Cryptocurrencies use a distributed layer technology known as blockchain. Blockchains act as a decentralized system for recording and documenting transactions that involve a specific digital currency. In essence, blockchain is a transaction ledger that maintains identical copies across each computer of a member network and the fact that the ledger is distributed across part of the network facilitates the security of blockchain. Given these security features, blockchain technology is on a significant growth path with companies across a wide variety of industries. A blockchain relies on three important components that are private key technology, a distributed network that includes a shared ledger and an accounting means for the transactions and records across the network. A blockchain is a list of records (called blocks) that are cryptographically linked together such that each block contains a cryptographic hash of the previous block, a timestamp, and transaction data. Thus, a blockchain is highly resistant to date modification due to the design feature that once recorded the data in any given block cannot be altered without alteration of all subsequent blocks. In many applications, the constructed distributed ledger is managed by a peer-to-peer network that allows participants to verify and audit transactions in an efficient manner. By combining the use of cryptographic keys with a distributed network, blockchain expands the type and number of digital transaction possibilities. However, despite their advantages the adoption of these available digital currencies and distribution systems in the insurance field is limited to date.

Accordingly, there is need for a system and method that improves upon the processing of insurance claims and policies using blockchains and cryptocurrencies.

### SUMMARY OF THE INVENTION

The present invention is directed to a system and method that facilitate the processing of insurance claims and policies using blockchains and cryptocurrencies.

In a first implementation of the invention, a blockchain-based insurance claim transaction processing method is provided comprising: (i) receiving, from an insured party using a first device, a notice of claim on a second user device associated with an insurance provider; (ii) opening, using the second user device associated with the insurance provider, a new electronic claim record specific to the notice of claim received; (iii) populating, using the second user device associated with the insurance provider, the electronic claim record opened with information from at least one insurance policy applicable to the notice of claim; (iv) assigning, using the second user device associated with the insurance provider, the electronic claim record populated to an insurance claims examiner and an insurance claim adjuster, respectively; (v) issuing, using a third user device associated with the insurance claims adjuster, at least a claim acknowledgement letter to the insured party; (vi) receiving, by the second user device associated with the insurance provider, at least one report generated by the insurance claims adjuster using the third user device containing a recommended resolution to the notice of claim received; (vii) reviewing, using a fourth user device associated with the insurance claims examiner, the at least one report received; (viii) approving, using the second user device associated with the insurance provider, the recommended resolution; (ix) creating, using the second user device associated with the insurance provider, a final approved insurance claim resolution statement; and (x) initiating, using the second user device associated with the insurance provider, at least one cryptocurrency payment, based on the final approved insurance claim resolution statement created, to at least one digital wallet associated with the insured party; and wherein transactions in each step are executed via a blockchain-based insurance claims transaction system employing at least one smart contract thereon and are stored by the corresponding user device into a blockchain, the blockchain is updated at each step by the corresponding user device, and the blockchain is stored on each of the corresponding user devices.

In a second aspect, a blockchain-based insurance claims transaction system is provided for executing a blockchain-based insurance claim transaction processing method comprising (i) receiving, from an insured party using a first device, a notice of claim on a second user device associated with an insurance provider; (ii) opening, using the second user device associated with the insurance provider, a new electronic claim record specific to the notice of claim received; (iii) populating, using the second user device associated with the insurance provider, the electronic claim record opened with information from at least one insurance policy applicable to the notice of claim; (iv) assigning, using the second user device associated with the insurance provider, the electronic claim record populated to an insurance claims examiner and an insurance claim adjuster, respectively; (v) issuing, using a third user device associated with the insurance claims adjuster, at least a claim acknowledgement letter to the insured party; (vi) receiving, by the second user device associated with the insurance provider, at least one report generated by the insurance claims adjuster using the third user device containing a recommended resolution to the notice of claim received; (vii) reviewing, using a fourth user device associated with the insurance claims examiner, the at least one report received; (viii) approving, using the second user device associated with the insurance provider, the recommended resolution; (ix) creating, using the second user device associated with the insurance provider, a final approved insurance claim resolution statement; and (x) initiating, using the second user device associated with the insurance provider, at least one cryptocurrency payment, based on the final approved insurance claim resolution statement created, to at least one digital wallet associated with the insured party; and wherein transactions in each step are executed via the blockchain-based insurance claims transaction system employing at least one smart contract thereon and are stored by the corresponding user device into a blockchain, the blockchain is updated at each step by the corresponding user device, and the blockchain is stored on each of the corresponding user devices.

In a third aspect, a blockchain-based insurance claims transaction application (alternatively referred to herein as an “app”) is provided for executing, on a user device or other hardware, a blockchain-based insurance claim transaction processing method comprising: (i) receiving, from an insured party using a first device, a notice of claim on a second user device associated with an insurance provider; (ii) opening, using the second user device associated with the insurance provider, a new electronic claim record specific to the notice of claim received; (iii) populating, using the second user device associated with the insurance provider, the electronic claim record opened with information from at least one insurance policy applicable to the notice of claim; (iv) assigning, using the second user device associated with the insurance provider, the electronic claim record populated to an insurance claims examiner and an insurance claim adjuster, respectively; (v) issuing, using a third user device associated with the insurance claims adjuster, at least a claim acknowledgement letter to the insured party; (vi) receiving, by the second user device associated with the insurance provider, at least one report generated by the insurance claims adjuster using the third user device containing a recommended resolution to the notice of claim received; (vii) reviewing, using a fourth user device associated with the insurance claims examiner, the at least one report received; (viii) approving, using the second user device associated with the insurance provider, the recommended resolution; (ix) creating, using the second user device associated with the insurance provider, a final approved insurance claim resolution statement; and (x) initiating, using the second user device associated with the insurance provider, at least one cryptocurrency payment, based on the final approved insurance claim resolution statement created, to at least one digital wallet associated with the insured party; and wherein transactions in each step are executed employing at least one smart contract and are stored by the corresponding user device into at least one blockchain utilized and managed by a blockchain-based insurance claims transaction system; the at least one blockchain is updated at each step by the corresponding user device; and the at least one blockchain is stored on each of the corresponding user devices.

In a further aspect, the function and associated operations of an insurance adjuster and/or insurance examiner may be performed singularly by an insurance provider.

In a further aspect, the function, and associated operations, of an insurance adjuster and/or insurance examiner may be performed in a consolidated fashion by a single individual (e.g., an insurance examiner or insurance adjuster, or vice versa).

In a further aspect, the insurance claims transaction app may be a mobile application executing on a mobile device and wherein the mobile device may be a smartphone, laptop computer, tablet and/or wearable device.

In a further aspect, the blockchain-based insurance claims transaction system executing the blockchain-based insurance claim transaction processing method further comprises: reviewing, using the fourth user device associated with the insurance claims examiner, the at least one invoice received and issuing an invoice payment recommendation; approving, using the second user device associated with the insurance provider, the invoice payment recommendation; and initiating, using the second user device associated with the insurance provider, at least one cryptocurrency payment, based on the invoice payment recommendation approved, to at least one digital wallet associated with the third-party expert.

In a further aspect, payments are made in a digital currency.

In a further aspect, the digital currency is one of a cryptocurrency, a virtual currency, a central bank digital currency (CBDC), and a digital currency electronic payment (DCEP).

In a further aspect, the blockchain-based insurance claims transaction system provides for an option to have payments issued in a cryptocurrency, a digital currency and/or a fiat currency.

In a further aspect, a sanction check is executed as fraud protection measure to verify the identities of the payees/insured parties (e.g., international claim payments).

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a high-level block diagram of a cloud network services architecture for providing a blockchain-based insurance claims transaction system in accordance with an embodiment.

FIG. 2 presents an illustrative blockchain-based insurance claims transaction system in accordance with an embodiment.

FIG. 3 presents an illustrative user device configured for use with the blockchain-based insurance claims transaction system of FIG. 2 in accordance with an embodiment.

FIG. 4 presents an illustrative architecture for a blockchain-based insurance claims transaction system app in accordance with an embodiment.

FIG. 5 presents an illustrative mesh network between various parties for processing an insurance claim transaction using the blockchain-based insurance claims transaction system of FIG. 2 in accordance with an embodiment.

FIG. 6 presents an illustrative insurance claim transaction blockchain interaction between various parties using the blockchain-based insurance claims transaction system of FIG. 2 in accordance with an embodiment.

FIG. 7 presents a flowchart of illustrative operations for insurance claims transaction processing using the blockchain-based insurance claims transaction system of FIG. 2 in accordance with an embodiment.

FIG. 8 presents a flowchart of illustrative operations for insurance claims transaction processing involving payment of third-party expert invoices using blockchain-based insurance claims transaction system of FIG. 2 in accordance with an embodiment.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in the figures herein. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed toward a blockchain-based system and method that provides for blockchain-based insurance claims transaction processing that improves upon the processing of insurance claims and policies using blockchains and cryptocurrencies for various forms of payments. As such, users (e.g., insured parties and insurance providers) may submit, process, review, approve, decline, issue payments and/or electronically process insurance claim transactions in a fully secure fashion and in compliance with applicable and governing insurance policies. Importantly, the blockchain-based insurance claims transaction system and method of the disclosed embodiments provides an advantageous improvement of at least one practical application, i.e., the processing of insurance claims transactions and insurance payment settlements. This solves a security problem and increases the security of insurance claims transaction processing and provides for the payment of insurance settlements and/or other third-party payments (e.g., third-party experts) using cryptocurrencies. This decreases the potential for fraud and increases the overall transactions processing efficiency. Importantly, in accordance with the principles of the disclosed embodiments, the transactions in each step are executed employing at least one smart contract and are stored by the corresponding user device into at least one blockchain utilized and managed by a blockchain-based insurance claims transaction system; the at least one blockchain is updated at each step by the corresponding user device; and the at least one blockchain is stored on each of the corresponding user devices.

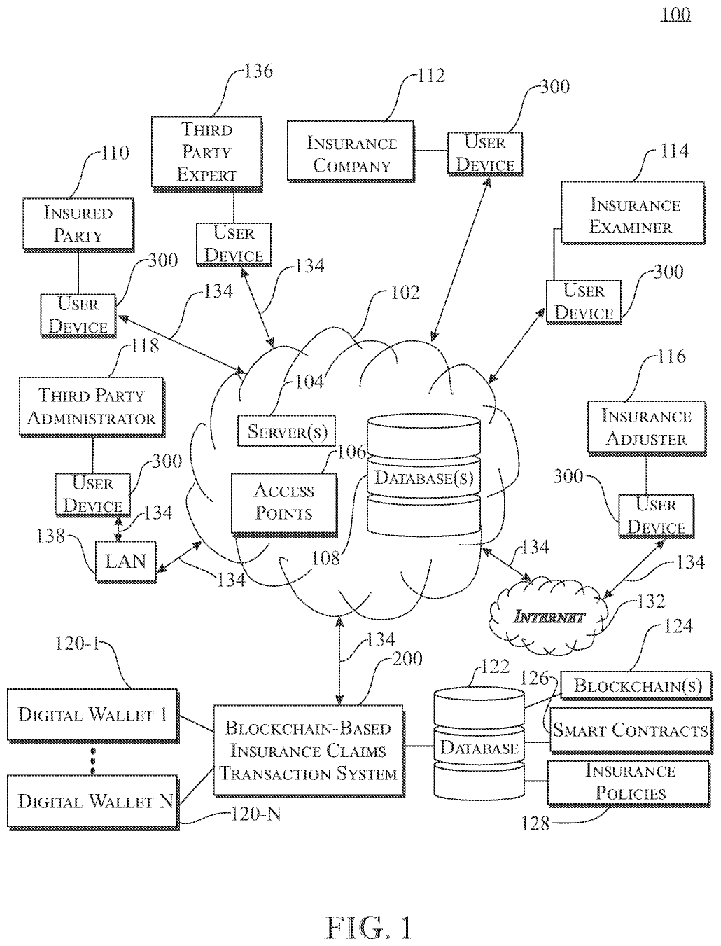

FIG. 1 presents a high-level block diagram of a cloud network services architecture 100 for providing a blockchain-based insurance claims transaction system in accordance with an embodiment. For clarity and the avoidance of doubt, it will be understood that the use of the term “party” or “user” herein means any type of party or user including, but not limited, an individual or corporate entity that may be involved in a particular insurance claims transaction including, but not limited, insurance companies, insurance syndicates, insurance carriers, insurance providers, insurance underwriters, Lloyds Syndicates, Managing General Agents (MGA), Coverholders, any entity acting on behalf of an insurance company with delegated authority (hereinafter referred to as a “Delegated Authorized Party”), independent insurance adjusting companies, self-insured retentions, and/or third-party administrators. By way of example but not limitation, a U.S.-based, third-party administrator may use a foreign-based insurance company to facilitate the making of payments and holding insurance funds in the U.S. in order to expedite and increase payment efficiency. Such parties of the blockchain-based insurance claims transaction system hereunder are those that have registered accordingly, as will be further detailed herein below. Further, the use of the term “insurance policy” herein, whether in physical or electronic form depending on the context, shall mean any type of document, file, codicil, or other instrument that is associated with any type of insurance coverages.

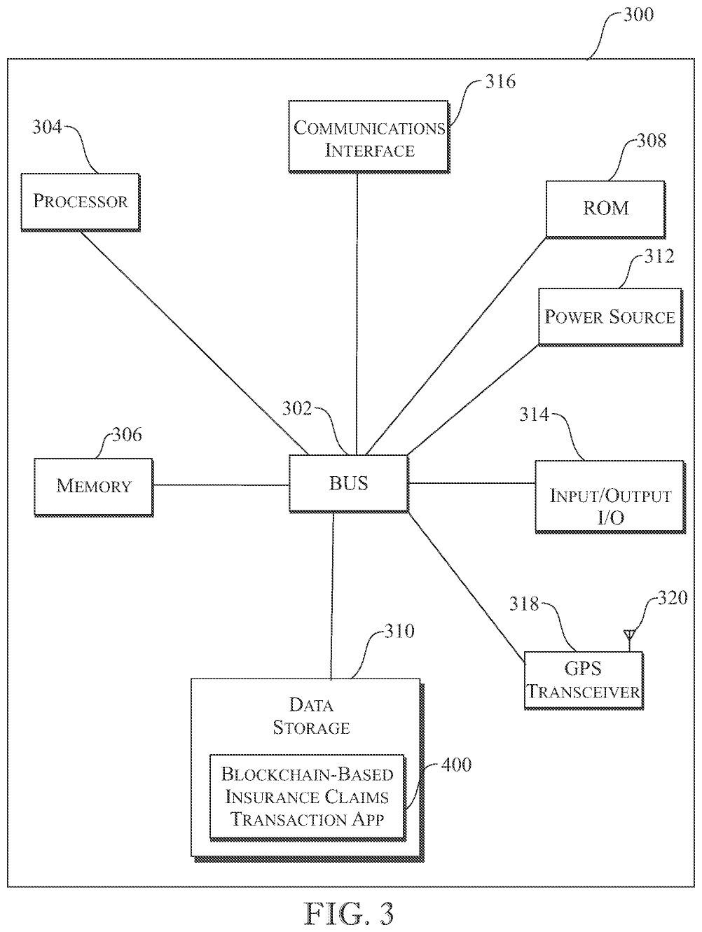

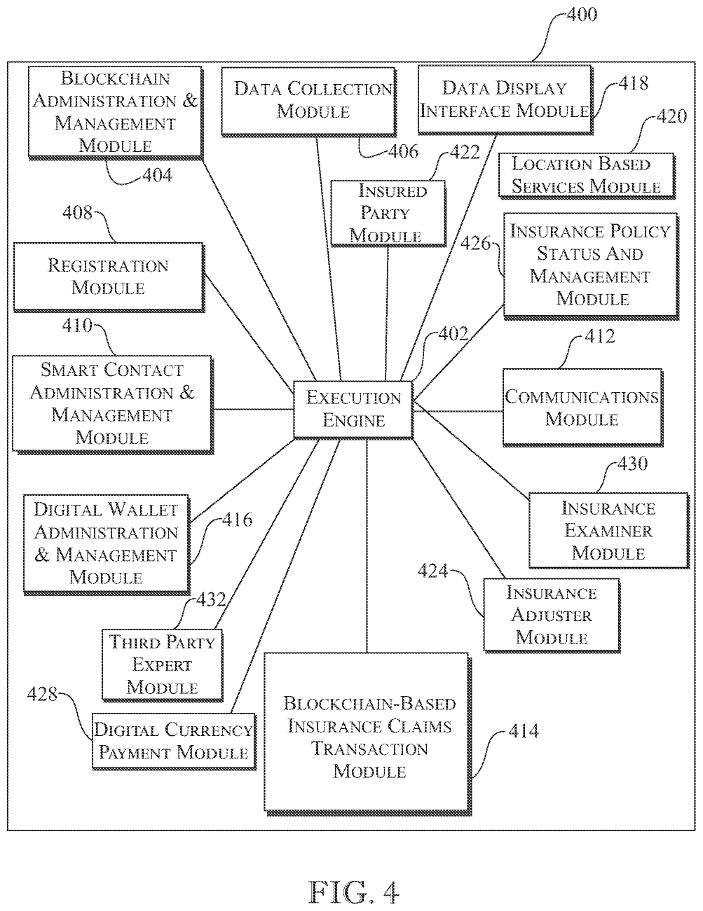

As shown for instance in FIG. 1, the cloud network services architecture 100 includes a cloud 102 comprising at least server(s) 104, access point(s) 106 and database(s) 108. As will be detailed herein below, the cloud 102 facilitates the delivery of the insurance claims transaction processing using blockchain-based insurance claims transaction system 200 to a plurality of parties (e.g., the plurality parties comprised by insured party 110, insurance company 112, insurance examiner 114, insurance adjuster 116, third-party administrator 118 and third-party expert 136), whereby the individual parties will play, individually and collectively, an important role in the overall insurance claims transaction process. In an embodiment, the insurance claims transaction processing, offered by and through the cloud network services architecture 100 and blockchain-based insurance claims transaction system 200 will be facilitated by a blockchain-based insurance claims transaction app 400 (see, FIG. 4), as will be detailed herein below, executing on a user device 300 (see, FIG. 3). The user device 300 provides the various parties (e.g., insured party 110, insurance company 112, insurance examiner 114, insurance adjuster 116, third-party administrator 118 and third-party expert 136) with real-time access to insurance claims transaction processing and payments in a blockchain-based system and methodology in accordance with the disclosed embodiments herein.

As will be appreciated, insurance claim adjusters plan and schedule the work required to process an insurance claim. They might, for example, handle the claim filed after an automobile accident or after a storm damages an insured party's home. For example, adjusters investigate claims by interviewing the claimant and witnesses, consulting police and hospital records, and inspecting property damage to determine how much the insurance company should pay for the loss under the governing insurance policy. Adjusters may consult with other professionals/third-party experts, such as accountants, architects, construction workers, engineers, lawyers, and physicians, who can offer a more expert evaluation of a claim. The information gathered (e.g., photographs and statements, either written, or recorded audio or video) is codified in a report that is then used to evaluate the claim. When (and if) the policyholder's claim is approved, the claims adjuster may negotiate in some instances with the claimant and settles the claim. When claims are contested, adjusters will work with attorneys and third-party expert witnesses to defend the insurer's position. Claims examiners within property and casualty insurance firms may have duties similar to those of an adjuster, but often their primary responsibility is to review claims after they are submitted in order to ensure that proper guidelines have been followed. They may assist adjusters with complicated claims or when, for instance, a natural disaster suddenly greatly increases the volume of claims. For example, in health insurance companies, claims examiners review health-related claims to see whether costs are reasonable given the diagnosis, and use guides that have information on the average period of disability, expected treatments, and average hospital stays for various ailments. Examiners check claim applications for completeness and accuracy, interview medical specialists, and consult policy files to verify the information reported in a claim. In life insurance applications, for example, claims examiners review the causes of death, particularly in the case of an accident, since most life insurance policies pay additional benefits if a death is accidental. Claims examiners also may review new applications for life insurance to make sure that the applicants have no serious illnesses that would make them a high risk to insure. They then authorize appropriate payment, deny the claim, or refer the claim to an investigator for a more thorough review. Insurance claims examiners may also specialize in group or individual insurance plans and in hospital, dental, or prescription drug claims. For clarity, it will be understood that while FIG. 1 shows both the insurance examiner 114 and the insurance adjuster 116 as separate individuals (with an associated user device 300) in various embodiments consistent with the disclosed principles hereunder the functions of the insurance examiner and the insurance adjuster may be performed in a consolidated manner by a single individual (e.g., the insurance examiner 114 or the insurance adjuster 116, or vice versa). Further, the principles of the disclosed embodiments, apply equally to embodiments whereby the function and associated operations of an insurance adjuster and/or insurance examiner may be performed singularly by an insurance provider. Alternatively, the insurance adjuster and/or the insurance examiner may be employees of the insurance provider and perform their function is such capacity. That is, an insurance examiner, for example, may typically be employed by the insurance provider and such insurance examiners, in turn, may review insurance adjusters (independent from the insurance provider) reports. For example, as will be appreciated, the insurance examiner 114 may perform so-called “desk adjusting” of any insurance claim thereby consolidating the function of the insurance adjuster 116 therewith. Similarly, in an embodiment, the insurance adjuster 116 may perform both the examination and the adjusting insurance claims processing functions in their entirety thereby consolidating the function of the insurance examiner 114 therewith.

As noted above, the cloud 102 comprises at least server(s) 104, the access point(s) 106 and the database(s) 108. Cloud, cloud service, cloud server and cloud database are broad terms and are to be given their ordinary and customary meaning to one of ordinary skill in the art and includes, without limitation, any database, data repository or storage media which store content typically associated with and managed by users, insurance claims processing services, insurance regulatory bodies, insured parties, insurance providers, third-party insurance experts, and third-party content providers, to name just a few. A cloud service may include one or more cloud servers and cloud databases that provides for the remote storage of content as hosted by a third-party service provider or operator. A cloud server may include an HTTP/HTTPS server sending and receiving messages in order to provide web-browsing interfaces to client web browsers as well as web services to send data to integrate with other interfaces (e.g., as executed on the user device 300). The cloud server may be implemented in one or more servers and may send and receive content in a various forms and formats, user supplied and/or created information/content and profile/configuration data that may be transferred to, read from, or stored in a cloud database (e.g., the databases 108).

A cloud database may include one or more physical servers, databases or storage devices as dictated by the cloud service's storage requirements. The cloud database may further include one or more well-known databases (e.g., an SQL database) or a fixed content storage system to store content, insurance policies, profile information, configuration information or administration information as necessary to execute the cloud service. In various embodiments, one or more networks providing computing infrastructure on behalf of one or more users may be referred to as a cloud, and resources may include, without limitation, data center resources, applications (e.g., software-as-a-service or platform-as-a-service) and management tools. In this way, in accordance with various embodiments, the users may control, initiate, and engage in the insurance claims transaction processing herein in a fully transparent fashion without any required understanding of the underlying hardware and software necessary to interface, communicate, manipulate, and exchange information and/or data necessary to deliver such services.

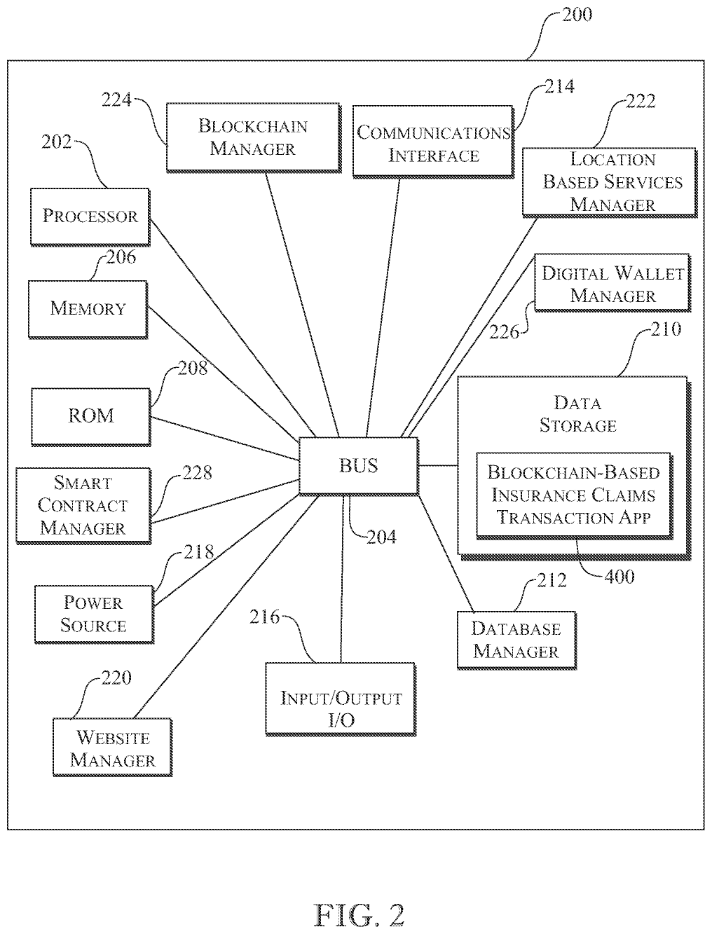

Turning our attention to FIG. 2, an illustrative configuration for the blockchain-based insurance claims transaction system 200 is shown for deployment in the cloud network services architecture 100 in accordance with an embodiment. As shown, the blockchain-based insurance claims transaction system 200 comprises processor 202 for executing program code (e.g., blockchain-based insurance claims transaction app 400) and communications interface 214 for managing communications to and from the blockchain-based insurance claims transaction system 200, memory 206 and/or ROM 208 for storing program code and data, and power source 218 for powering the blockchain-based insurance claims transaction system 200. The memory 206 is coupled to the bus 204 for storing computer-readable instructions to be executed by the processor 200 (e.g., execution of the blockchain-based insurance claims transaction app 400). Database manager 212 is used to manage the delivery and storage of content, data, and other information in the database(s) 122, database(s) 108 and across third-party content providers, for example. The database(s) 122 may store and provide information including, but not limited, to blockchain(s) 124, smart contracts 126, and insurance policies 128. The digital wallet manager 226 may be used to manage the individual digital wallets (e.g., digital wallet 1 120-1 through digital wallet N 120-N) associated with a user into which a cryptocurrency payment will be delivered in accordance with the principles of the embodiments herein.

Website manager 220 is used to deliver and manage content, data, and other information across one or more websites that may be utilized to access and use the blockchain-based insurance claims transaction system 200, for example. Further, the operations provided by and through the blockchain-based insurance claims transaction app 400 may be offered through a web-based application. As will be discussed in greater detail herein below, the blockchain-based insurance claims transaction app 400, as stored in data storage 210, when executed by the processor 202 will enable access by a plurality of parties (e.g., insured party 110, insurance company 112, insurance examiner 114, insurance adjuster 116, third-party administrator 118 and third-party expert 136) to the blockchain-based insurance claims transaction system 200 for the processing of a notice of insurance claim filed by the insured party 110, for example, under a particular insurance policy that such parties are responsible for resolving. Location-based service manager 222 facilitates the delivery of location-based services (e.g., GPS tracking) either independently or on user device 300 thereby allowing the blockchain-based insurance claims transaction system 200 to register the exact location of the user of the user device 300, for example, as the user roams from one location to another location such that the services offered via the insurance claims transaction processing hereunder may be tailored to a current location and/or the needs of the user/party may change based on their current location. For example, the insured party 110 may have been involved in a car accident and is need of immediate medical attention.

In an embodiment, the insurance claims transaction processing provided through the execution of the blockchain-based insurance claims transaction app 400 may also include a web-based delivery platform and/or accessing and interfacing any number of web using website manager 220 for procuring information and data that can be used in the blockchain-based insurance claims transaction system 200. The term “website” in the context herein is used in a conventional and broadest sense and is located on at least one server containing web pages stored thereon and is operational in a 24-hour/7-day typical fashion. Further, as shown in the cloud network services architecture 100, the plurality of parties (i.e., insured party 110, insurance company 112, insurance examiner 114, insurance adjuster 116, third-party administrator 118 and third-party expert 136) may alternatively utilize well-known Internet 132 for access to blockchain-based insurance claims transaction system 200 by and through a web browser on the user device 300, for example.

The communications interface 214 is used to facilitate communications across the communications links 134 (see, FIG. 1) within the cloud network services architecture 100. This may take the form, for example, of a wide area network connection that communicatively couples the blockchain-based insurance claims transaction system 200 with the access points 106 (see, FIG. 1) which may be a cellular communications service. Similarly, communications managed by the communications interface 214 may take the form, for example, of a local Wi-Fi network interface or Ethernet interface the communicatively couples the blockchain-based insurance claims transaction system 200 with the Internet 132, LAN 138 and ultimately the user device 300. In the instant embodiment, the blockchain-based insurance claims transaction app 400 and/or the communications interface 214 may include a communications stack for facilitating communications over the respective communications link 134. Electronic communications by and through blockchain-based insurance claims transaction system 200 between the various systems, networks, devices, users, entities, and/or individuals are facilitated by the communications links 134 in accordance with any number of well-known communications protocols and methods (e.g., wireless communications).

Turning our attention briefly to FIG. 3, an illustrative user device 300 is shown for deployment with the cloud network services architecture 100 of FIG. 1 in accordance with an embodiment. The user device 300 typically includes bus 302 and processor 304 coupled to the bus 302 for executing operations and processing information. As will be appreciated, a “user device” in the context herein may comprise a wide variety of devices such as any type of mobile device, smartphones, laptop computers, desktop computers, tablets, and wearable device, to name just a few, that execute applications (e.g., a mobile application) in accordance with the principles of the disclosed embodiments herein. For example, the execution of the operations of blockchain-based insurance claims transaction app 400 as will be discussed in much greater detail herein below. The processor 304, as powered by power source 312, may include both general and special purpose microprocessors, and may be the sole processor or one of multiple processors of the device. This is equally applicable to the processor 202 of FIG. 2. Further, the processor 304 (or the processor 202) may comprise one or more central processing units (CPUs) and may include, be supplemented by, or incorporated in, one or more application-specific integrated circuits (ASICs) and/or one or more field programmable gate arrays (FPGAs).

The user device 300 may also include memory 306 coupled to the bus 302 for storing computer-readable instructions to be executed by the processor 304. The memory 306 may also be utilized for storing temporary variables or other intermediate information during the execution of the instructions by the processor 304. The user device 300 may also include read-only memory (ROM) 308 or other static storage device coupled to the bus 302. Further, data storage device 310, such as a magnetic, optical, or solid-state device may be coupled to the bus 302 for storing information and instructions for the processor 304 including, but not limited to, the blockchain-based insurance claims transaction app 400. Data storage device 310 (or the data storage device 210) and the memory 306 (and the memory 206) may each comprise a tangible non-transitory computer readable storage medium and may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

The user device 300 may also include one or more communications interface 316 for communicating with other devices via a network (e.g., a wireless communications network) or communications protocol (e.g., Bluetooth®). For example, such communication interfaces may be a receiver, transceiver, or modem for exchanging wired or wireless communications in any number of well-known fashions. For example, the communications interface 316 (or the communications interface 214) may be an integrated services digital network (ISDN) card or modem/router used to facilitate data communications of various well-known types and formats. Further, illustratively, the communications interface 316 (or the communications interface 214) may be a local area network (LAN) card used to provide data communication connectivity to a comparable LAN. Wireless communication links may also be implemented. The Global Positioning System (GPS) transceiver 318 and antenna 320 facilitate delivery of location-based services in order to register the exact location of the user device 300, for example, as the user roams from one location to another location.

As will be appreciated, the functionality of the communication interface 316 (or the communications interface 214) is to send and receive a variety of signals (e.g., electrical, optical, or other signals) that transmit data streams representing various data types. The user device 300 may also include one or more input/output devices 314 that enable user interaction with the user device 300 (e.g., camera, display, keyboard, mouse, speakers, microphone, buttons, etc.). The input/output devices 314 (or the I/O devices 216) may include peripherals, such as a camera, printer, scanner, display screen, etc. For example, the input/output devices 314 (or I/O devices 216) may include a display device such as a cathode ray tube (CRT), plasma monitor, liquid crystal display (LCD) monitor or organic light-emitting diode (OLED) monitor for displaying information to the user, a keyboard, and a pointing device such as a mouse or a trackball by which the user can provide input to the user device 300 or an associated display device, for example. As detailed herein, while FIG. 3 describes an embodiment of the blockchain-based insurance claims transaction app 400 for execution, illustratively, on the user device 300 it will also be understood that other hardware devices may be used to execute and operate the blockchain-based insurance claims transaction app 400 in any real-time setting including but not limited to the cloud network services architecture 100. For example, a network-enabled portable tablet computer and/or dedicated portable hardware device may be employed equally in the context of the disclosed embodiments.

Turning our attention to FIG. 4, an illustrative architecture for the operation of the blockchain-based insurance claims transaction app 400 is presented in accordance with an embodiment. As will be appreciated, the architecture may be used in conjunction with the cloud network services architecture 100, the blockchain-based insurance claims transaction system 200, and/or the user device 300 for launching and executing the blockchain-based insurance claims transaction app 400 and its associated operations. As shown, the architecture for the operations of the blockchain-based insurance claims transaction app 400 provides several interfaces and engines used to perform a variety of functions such as the collection, aggregation, manipulation, processing, analyzing, verification, authentication, and display of applicable real-time information and data that are useful to achieve the insurance claims transaction processing of the disclosed embodiments. More particularly, data display interface module 418 and communications module 412 are used to facilitate the input/output and display of electronic data and other information to, illustratively, the users (e.g., insured party 110, insurance company 112, insurance examiner 114, insurance adjuster 116, third-party administrator 118 and third-party expert 136) employing the user device 300 (e.g., a touch screen of the user device 300) and executing the blockchain-based insurance claims transaction app 400. The data collection interface module 406 facilitates the collection of relevant insurance claim, insurance policy and/or other applicable information from the plurality of parties (i.e., insured party 110, insurance company 112, insurance examiner 114, insurance adjuster 116, third-party administrator 118 and third-party expert 136) and/or other third parties. The location-based services module 420 provides for the delivery of location-based services in order for the geographic locations of the parties to be identified and displayed (e.g., GPS locations). The communications module 412 will facilitate communications by and through the blockchain-based insurance claims transaction system 200, for example.

Execution engine 402 may be employed to deliver the insurance claims transaction processing herein through the execution of the blockchain-based insurance claims transaction app 400. In such delivery, the execution engine 402 will operate and execute, as further detailed herein below, with at least the following program modules: blockchain administration & management module 404, data collection module 406, data display interface module 418, location-based services module 420, registration module 408, smart contract administration & management module 410, communications module 412, blockchain-based insurance claims transaction module 414, digital wallet administration & management module 416, insured party module 422, insurance adjuster module 424, insurance policy status & management module 426, digital currency payment module 428, insurance examiner module 430, and third-party expert module 432. The operations executed by the foregoing modules will now be further discussed in greater detail.

Those skilled in the art will appreciate that the present disclosure contemplates the use of systems configurations and/or computer instructions that may perform any or all of the operations involved in blockchain-based insurance claims transaction processing. The disclosure of computer instructions that include, for example, the blockchain-based insurance claims transaction app 400 and the blockchain-based insurance claims transaction system 200 instructions is not meant to be limiting in any way. Those skilled in the art will readily appreciate that stored computer instructions and/or systems configurations may be configured in any way while still accomplishing the various goals, features, and advantages according to the present disclosure. The terms “program,” “application,” “software application,” and the like as used herein, are defined as a sequence of instructions designed for execution on a computer system. A “program,” “computer program,” “application,” or “software application” may include a subroutine, a function, a procedure, an object method, an object implementation, an executable application, an applet, a servlet, a source code, an object code, a shared library/dynamic load library, and/or other sequence of instructions designed for execution on a computer system.

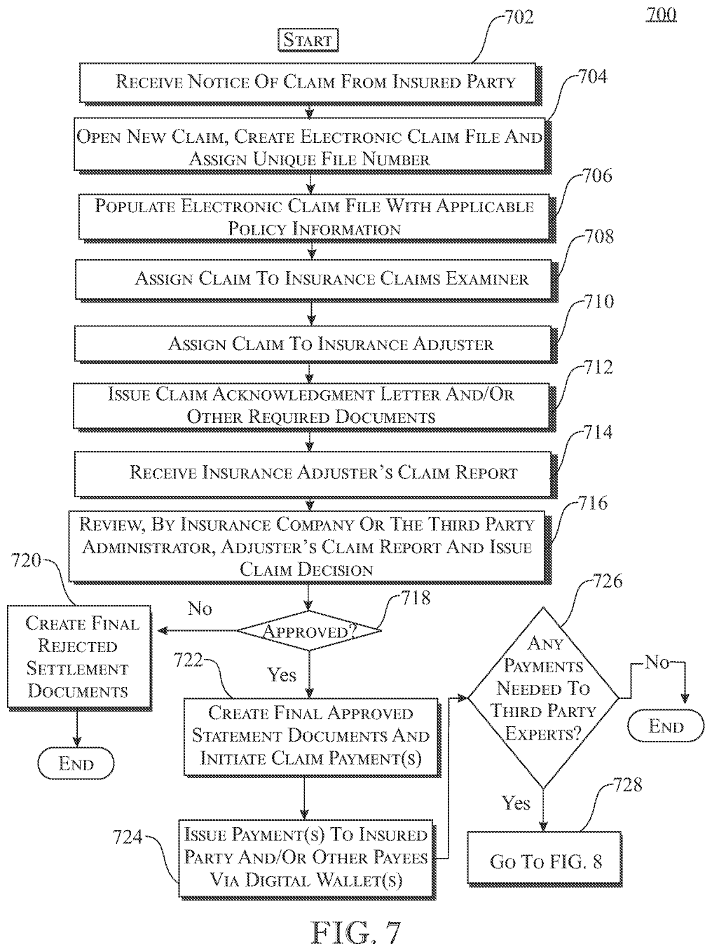

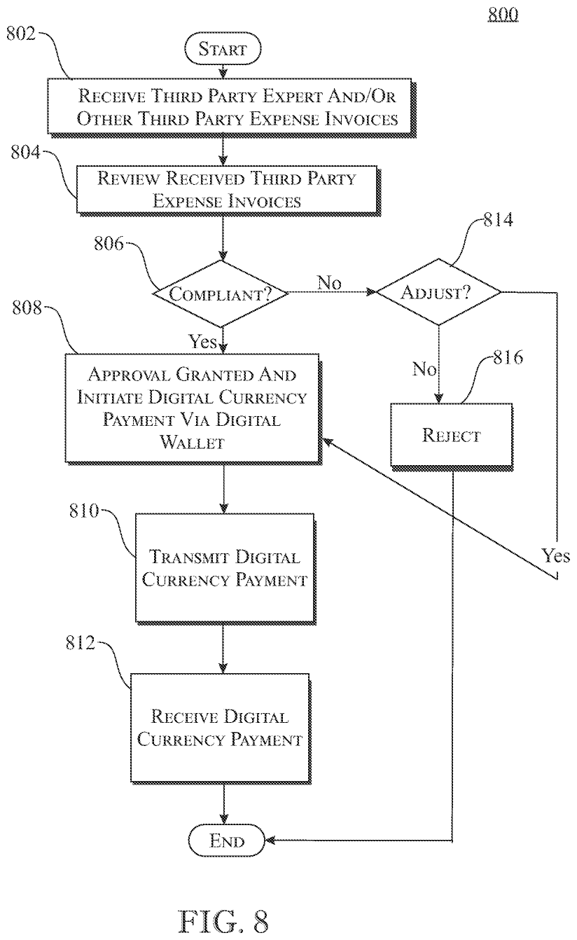

Turning our attention to FIG. 7, a flowchart of illustrative operations 700 are shown for insurance claims transaction processing method using the blockchain-based insurance claims transaction system of FIG. 2 in accordance with an embodiment. Importantly, the transactions in each step are executed via the blockchain-based insurance claims transaction system employing at least one smart contract thereon and are stored by a corresponding user device into a blockchain, the blockchain is updated at each step by the corresponding user device, and the blockchain is stored on each of the corresponding user devices. In accordance with FIG. 7, the operations 700 comprising, at step 702, receiving, from an insured party using a first device, a notice of claim on a second user device associated with an insurance provider. At step 704, opening, using the second user device associated with the insurance provider, a new electronic claim record specific to the notice of claim received, and populating, using the second user device associated with the insurance provider, at step 706, the electronic claim record opened with information from at least one insurance policy applicable to the notice of claim. Then, at steps, 708 and 710, assigning, using the second user device associated with the insurance provider, the electronic claim record populated to an insurance claims examiner and an insurance claim adjuster, respectively, and issuing, using a third user device associated with the insurance claims adjuster, at least a claim acknowledgement letter to the insured party, at step 712. As will be understood, each insurance claim is different having varying issues, facts, and parties. When claims are not instantly approved and paid, or immediately denied, they are subject to a rigorous review process as detailed herein. The review process itself may include the issuance of a variety of documents, codicils, and letters. For example, letters may be issued directed to reservation of rights, partial denials, claim acknowledgements, and insurance claim resolution statements, to name just a few. As will be appreciated, an insurance claim resolution statement includes, but is not limited to, a statement of loss for all purposes hereunder. Further, receiving, by the second user device associated with the insurance provider, at step 714, at least one report generated by the insurance claims adjuster using the third user device containing a recommended resolution to the notice of claim received, and reviewing, using a fourth user device associated with the insurance claims examiner, at step 716, the at least one report received. As noted previously, while the discussion of the operations shown FIG. 7 includes both the insurance examiner (e.g., the insurance examiner 114) and the insurance adjuster (e.g., the insurance examiner 116) contemplates separate individuals (with an associated user device 300) in various embodiments consistent with the disclosed principles hereunder the functions and associated operations of the insurance examiner and the insurance adjuster may be performed in a consolidated manner by a single individual (e.g., the insurance examiner 114 or the insurance adjuster 116). For example, as will be appreciated, the insurance examiner 114 may perform so-called “desk adjusting” of any insurance claim thereby consolidating the function of the insurance adjuster 116 therewith. Similarly, in an embodiment, the insurance adjuster 116 may perform both the examination and the adjusting insurance claims processing functions in their entirety thereby consolidating the function of the insurance examiner 114 therewith. In this way, the aforementioned steps (or in a similar fashion the operations detailed herein below with respect to FIG. 8) associated with the insurance adjuster function may be performed, illustratively, in a consolidated fashion with the steps associated with the insurance examiner in a further embodiment. Similarly, in an embodiment, the steps associated with insurance examiner function may be consolidated with the steps associated with the insurance adjuster.

Then, at step 718, determining whether to approve, using the second user device associated with the insurance provider, the recommended resolution. If not approved, then creating, as step 720, the final rejected settlements documents for communication to the insured party that their claim has been denied. If approved, then at step 722, creating, using the second user device associated with the insurance provider a final approved insurance claim resolution statement. Then, at step 724, initiating, using the second user device associated with the insurance provider, at least one cryptocurrency payment, based on the final approved insurance claim resolution statement created, to at least one digital wallet associated with the insured party. In an embodiment, a sanction check may be executed as a fraud protection measure to verify the identities of the payees/insured parties (e.g., international claim payments) prior to issuing the payment. At step 726, determining whether any payments are needed to any third-party experts and, if so, then at step 728 the operations continue as set forth in FIG. 8, as detailed next herein below. If no third-party expert payments are necessary, then the operations end. As noted above, wherein transactions in each step are executed via the blockchain-based insurance claims transaction system employing at least one smart contract thereon and are stored by the corresponding user device into a blockchain, the blockchain is updated at each step by the corresponding user device, and the blockchain is stored on each of the corresponding user devices.

FIG. 8 presents a flowchart of illustrative operations for insurance claims transaction processing involving payment of third-party expert invoices using blockchain-based insurance claims transaction system of FIG. 2 in accordance with an embodiment. As will be appreciated, such third-party invoices include, but are not limited to, so-called loss adjustment expenses (LAE). At step 802, receiving, by the second user device associated with the insurance provider, at least one invoice generated by at least one third-party expert using a fifth user device, and reviewing, at step 804, using the fourth user device associated with the insurance claims examiner, the at least one invoice received and issuing an invoice payment recommendation. At step 806, determining whether the at least one invoice received is compliant with the underlying third-party contract, for example, governing the work provided by the expert. If not, then at step 814 determining if any adjustment is appropriate and, if so, adjusting, using the second user device associated with the insurance provider, the at least one invoice received based on the invoice payment recommendation reviewed. If not fully compliant, then reject at step 816 and the operations end. If fully compliant, then approving, using the second user device associated with the insurance provider, the invoice payment recommendation, at step 808, and initiating, using the second user device associated with the insurance provider, at least one cryptocurrency payment, based on the invoice payment recommendation approved, to at least one digital wallet associated with the third-party expert. Then, at step 810, transmitting the digital currency payment to the third-party expert's digital wallet and receiving, at step 812, the digital currency payment by the third-party expert's digital wallet. Again, in accordance with the principles of the disclosed embodiments, wherein transactions in each step are executed via the blockchain-based insurance claims transaction system employing at least one smart contract thereon and are stored by the corresponding user device into a blockchain, the blockchain is updated at each step by the corresponding user device, and the blockchain is stored on each of the corresponding user devices.

In this way, the blockchain-based system and method provides for blockchain-based insurance claim transaction processing that improves upon the processing of insurance claims and policies using blockchains and cryptocurrencies for various forms of payments. As such, users (e.g., insured parties and insurance providers) may submit, process, review, approve, decline, issue payments and/or electronically process insurance claim transactions in a fully secure fashion and in compliance with applicable and governing insurance policies. Importantly, the blockchain-based insurance claims transaction system and method of the disclosed embodiments provides an advantageous improvement of at least one practical application, i.e., the processing of insurance claims transactions and insurance payment settlements. This solves a security problem and increases the security of insurance claims transaction processing and provides for the payment of insurance settlements and/or other third-party payments (e.g., third-party experts) using cryptocurrencies. This decreases the potential for fraud and increase the overall transactions processing efficiency.

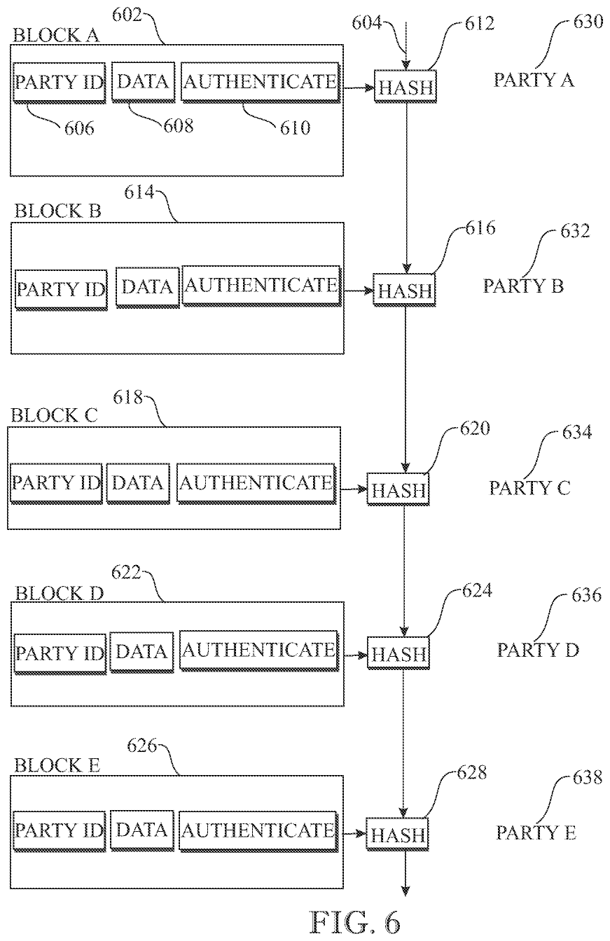

As detailed herein, the insurance claims transaction processing is enabled by and executed through the blockchain-based insurance claims transaction system 200 and the blockchain-based insurance claims transaction app 400. Importantly, in accordance with the principles of the disclosed embodiments, the transactions in each step are executed employing at least one smart contract (e.g., smart contracts 126) and are stored by the corresponding user device (e.g., the user device 300) into at least one blockchain (see, e.g., blockchain 604 in FIG. 6) utilized and managed by a blockchain-based insurance claims transaction system (e.g., the blockchain-based insurance transactions system 200); the at least one blockchain is updated at each step by the corresponding user device; and the at least one blockchain is stored on each of the corresponding user devices. Blockchain is a distributed database that records all transactions that have ever occurred in a network. Blockchain was originally introduced for Bitcoin (a peer-to-peer digital payment system), but then evolved to be used for developing a wide range of decentralized applications. A blockchain is a distributed digital ledger which is communicated electronically between hardware devices (e.g., the user device 300). Each transaction recorded within the digital ledger is a block which can be hashed or other encrypted. As new transactions are added to the digital ledger, each transaction's veracity can be tested against the previous ledger stored by the devices. In some configurations, there may be a requirement that some fixed percentage (e.g., 50%) of the user devices must confirm the transaction's veracity before being added to the blockchain. As such, a blockchain is a distributed database that records all transactions that have ever occurred in the blockchain network. This database is replicated and shared among the network's participants (or a subset thereof in some implementations). The main feature of blockchain is that it allows untrusted participants to communicate and send transactions between each other in a secure way without the need of a trusted third party. Blockchain is an ordered list of blocks, where each block is identified by its cryptographic hash. Each block references the block that came before it, resulting in a chain of blocks. Each block consists of a set of transactions. Once a block is created and appended to the blockchain, the transactions in that block cannot be changed or reverted. This is to ensure the integrity of the transactions, for example, the insurance claims transaction in accordance with the principles of the embodiments herein.

An appealing application that can be deployed on top of blockchain are so-called smart contracts. A smart contract is executable code that runs on the blockchain to facilitate, execute, and enforce the terms of an agreement (e.g., an insurance policy) between parties. It can be thought of as a system that releases digital assets to all or some of the involved parties once the pre-defined rules have been met. The main aim of a smart contract is to automatically execute the terms of an agreement once the specified conditions are met. In this way, a smart contract functions as a trusted distributed application that gains its security/trust from the blockchain and the underlying consensus among the peers. In essence, serving as the business logic of a blockchain application (e.g., the insurance claims transaction processing hereunder). Thus, smart contracts promise low transaction fees compared to traditional systems that require a trusted third party to enforce and execute the terms of an agreement. Compared to traditional contracts, smart contracts do not rely on a trusted third party to operate, resulting in low transaction costs. There are different blockchain platforms that can be utilized to develop smart contracts, and Ethereum currently is the most common platform for developing smart contracts. Ethereum is a public blockchain platform that can support advanced and customized smart contracts with the help of Turing-complete programming language. The code of Ethereum smart contracts is written in a stack-based bytecode language and executed in Ethereum Virtual Machine (EVM). Several high-level languages (e.g., Solidity, Serpent and LLL) can be used to write Ethereum smart contracts. The code of those languages can then be compiled into EVM bytecodes to be run.

Another blockchain platform that is increasingly gaining traction is the Hyperledger Fabric (also referred to as “Fabric”) as established by the Linux Foundation (see, e.g., LFS272: Hyperledger Fabric Administration, version 8.24, dated May 26, 2021) with a major focus on enterprise uses that require participants to be identified/identifiable, permissioned networks, high transaction throughput performance, low latency of transaction confirmation and privacy and confidentiality of transactions and data pertaining to business transactions. Fabric is the first distributed ledger platform to support smart contracts authored in general-purpose programming languages such as Java, rather than domain-specific languages (DSL). As such, enterprises can more easily develop smart contracts without the need to learn a specific/new programming language. The Fabric platform is also permissioned in that, unlike a public permissionless network, the participants are known to each other, rather than anonymous and therefore fully untrusted. This means that while the participants may not fully trust one another (e.g., if they are adverse parties or competitors) a network can be operated under a governance model that is constructed as a function of whatever trust does exist between participants, such as a legal framework (e.g., an insurance policy). These features make Fabric one of the better performing platforms that are currently available both in terms of transaction processing and transaction confirmation latency. Further, this platform enables privacy and confidentiality of transactions and smart contracts that implement them.

As also detailed hereinabove, the principles of the disclosed embodiments employ cryptocurrency payments to digital wallets in terms of insurance settlement payouts and/or third-party payments (e.g, a third-party expert). Digital currency is a currency form that is available in electronic or digital form, but not in physical form. Digital currencies exist and are only accessible with electronic devices, for example, computers and smartphones. That is, digital currencies are intangible and are owned and transacted by using computers or electronic wallets that have access to the Internet or specifically designated computer networks. Digital currencies have all the intrinsic properties of physical currency (e.g, banknotes or minted coins) and allow for instantaneous transactions that are seamlessly executed for making payments across borders and geographic boundaries when the parties are interconnected to supported hardware devices and networks. Cryptocurrencies have emerged as the first generation of blockchain technology. Cryptocurrencies are basically digital currencies that are based on cryptographic techniques and peer-to-peer network. Today, a number of digital currencies variants, regulated or unregulated, exist such as cryptocurrencies and virtual currencies. A cryptocurrency is another form of digital currency that uses cryptography to secure and verify transactions and to manage and control the creation of new currency units. Currently, cryptocurrencies are unregulated so they may also be considered so-called virtual currencies. That is, virtual currencies are an unregulated digital currency that is controlled by its developers, a founding organization, or a defined network protocol. To be clear, the principles of the disclosed embodiments apply equally to any type of digital currency including, but not limited to, a cryptocurrency, a virtual currency, a central bank digital currency (CBDC), and a digital currency electronic payment (DCEP).

For instance, Bitcoin is a digital currency created in 2009 that offers the promise of lower transaction fees than traditional online payment forms and is operated by a decentralized authority in distinction from government-issue currencies, for example. There are no physical Bitcoins only public ledger balances that everyone has transparent access to that are verified by computer networks in the context of Bitcoin transactions. Bitcoins are not issued or backed by any banks or governments nor are individual Bitcoins valuable as a commodity themselves. They are not legal tender in the traditional sense, but their popularity has been on a recent rise. To buy Bitcoin, a person will download a Bitcoin digital wallet that will store the person's Bitcoins for future spending or trading. Bitcoin balances, given Bitcoin is not really a “coin,” are maintained using public and private keys that are long number strings and letters linked through mathematical encryption algorithms. A public key is the location where transactions are deposited to and withdrawn from, and the public key appears in a blockchain ledger as a user's digital signature. A private key is the password required to buy, sell, and trade Bitcoin in the Bitcoin wallet. In the U.S., the Securities and Exchange Commission requires users to verify their identities (e.g., using a driver's license or Social Security Number) when registering their digital wallets in an effort to promote anti-money laundering policies. Once established, the digital wallet can used like any other traditional payment method such as a credit card or debit card to buy Bitcoins on a Bitcoin exchange. Once purchased, the Bitcoins are transferred to the buyer's digital wallet.

In this way, blockchains act as a decentralized system for recording and documenting transactions that involve a specific digital currency. In essence, as noted previously, a blockchain is a transaction ledger that maintains identical copies across each computer of a member network and the fact that the ledger is distributed across part of the network facilitates the security of blockchain. A blockchain relies on three important components that are private key technology, a distributed network that includes a shared ledger and an accounting means for the transactions and records across the network. A blockchain is a list of records (called blocks) that are cryptographically linked together such that each block contains a cryptographic hash of the previous block, a timestamp, and transaction data. Thus, a blockchain is highly resistant to date modification due to the design feature that once recorded the data in any given block cannot be altered without alteration of all subsequent blocks. In many applications, the constructed distributed ledger is managed by a peer-to-peer network that allows participants to verify and audit transactions in an efficient manner. By combining the use of cryptographic keys with a distributed network, blockchain expands the type and number of digital transaction possibilities.

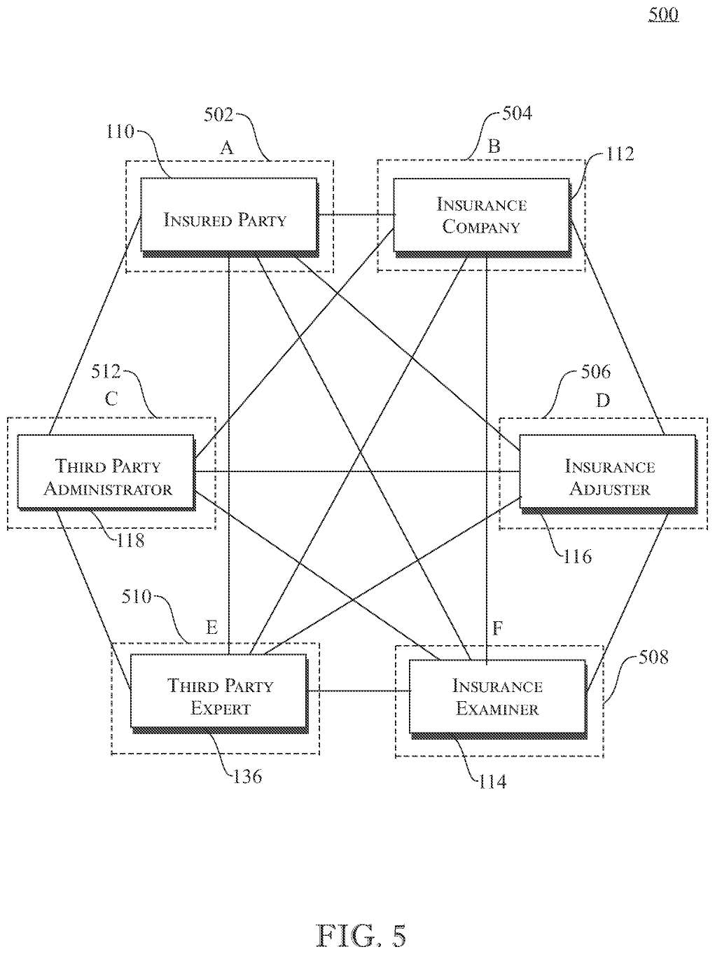

Turning our attention to FIG. 5, an illustrative mesh network 500 between various parties for processing an insurance claim transaction using the blockchain-based insurance claims transaction system of FIG. 2 in accordance with an embodiment. As shown, the illustrative mesh network 500 employs a peer-to-peer configuration that includes six (6) nodes between a plurality of parties. In particular, with reference to certain of the parties of the instant embodiments, node A 502 associated with the insured party 110, node B 504 associated with the insurance company 112, node C 512 associated with the third-party administrator 118, node D 506 associated with the insurance adjuster, node E 510 associated with third-party expert 136, and node F 508 associated with the insurance examiner 114. The illustrative mesh network 500 is configured such that each node can communicate with and relay data to each of the other nodes. In this way, the various parties may use their respective user devices (e.g., the user device 300) to communicate with each other across the mesh network 500 in performing the various operations and/or actions required by the blockchain-based claims transaction system 500 and associated insurance claims transaction processing.

Thus, in the framework of the principles of the disclosed embodiments, a blockchain is a public ledger of all transactions that have been executed in a particular context (e.g., the insurance claims transaction processing hereunder involving a notice of claim filed by an insurance party in accordance with a governing insurance policy). The blockchain constantly enlarges as completed blocks are added thereto as new transactions are addressed. Typically, blocks are added to the blockchain (see, e.g., blockchain 604 in FIG. 6) in a linear, chronological order by the various user devices involved in the transaction(s) and are interconnected in executing the blockchain protocol, for example, in a peer-to-peer network. The peer-to-peer network is essentially a plurality of interconnected nodes (e.g., node A 502, node B 504, node C 506, node D 508, node E 510, and node F 512) with each node associated with a particular user device the employs a client to validated and relay transactions (e.g., one of the relevant transactions specific to the insurance claims transactions processing hereunder). A copy of the blockchain is maintained by each node which is automatically downloaded to the node upon joining the blockchain. In turn, the blockchain protocol provides a secure and reliable mechanism for updating and distributing copies of the blockchain across the interconnected nodes.

Turning our attention to FIG. 6, an illustrative insurance claim transaction blockchain interaction between various parties is shown using the blockchain-based insurance claims transaction system 200 in accordance with an embodiment. In the case of the insurance claims transaction processing embodiments hereunder, blockchain 604 is distributed among multiple devices (i.e., the user device 300 associated with each party, see, e.g., FIG. 1) associated with multiple parties. For example, party A 630 (the insured party 110), party B 632 (the insurance company 112), party C 634 (the insurance claims examiner 114), party D 636 (the insurance claims adjuster 116), and party E (the third-party expert 136). In the example shown, block A 602 is added to the blockchain 604 and may contain party ID 606 of party A 630 or an address/identification of the user device 300 associated and used by the party A 630, and may also contain data 608 (e.g., relevant insurance claims transaction data). Also, the block A 602 may contain an authentication portion 610 that may be used to set restrictions of various levels on the data 608 and/or the party ID 606. For example, the party ID 606 and the data 608 may be set such that they are not accessible to one or more of the other parties. This may be advantageous if the insurance claims adjuster 116, for example, does not want the insured party 110 to have access to certain of the data 608 while the received notice of claim is under investigation and pending.

The data 608 may be part of one of the smart contracts 126 employed by the blockchain-based insurance claims transaction system 200 and associated operations in applying the insurance claims transaction processing hereunder. In turn, the smart contract 126 is stored on the blockchain 604 and executed automatically as part of the respective transactions executed. As the user device 300 generates the block 602, the block 602 is hashed 612 into the previous blockchain 604 resulting in an updated blockchain 604 which continues to be distributed among the various parties and their respective user devices. The blockchain protocol includes a so-called proof of work scheme that is based on a cryptographic hash function (CHF), for example, the secure hash algorithm 256 (SHA-256). Generally, the CHF receives information as input and provides a hash value output, wherein the hash value has a predetermined length. For example, SHA-256 provides a 256-bit (32-byte, 64 character) hash value output. The blockchain may also require multiple information pieces as input to the CHF. The input, for example, may include a reference to the previous (i.e., most recent) block in the blockchain, details of the transaction(s) that are to be included in the to-be-created block, and a nonce value (e.g., a random number used a single time). Further, the blockchain protocol provides a threshold hash to qualify a block to be added to the blockchain. For example, the threshold hash may include a predefined number of zeros (0's) that the hash value must have at the start, and the higher the number the more effort that is required to arrive at the qualifying hash. The other user devices 300 receive the updated blockchain 604 containing the block 602. Illustratively, party B 632 receives the blockchain 604 and generates block B 614 and store the respective data in the blockchain 604. Similar to block A 602, the block B 614 may store the respective transaction data of the party B 632, an ID of the party 632, or an address/identification of their respective user device 300, and an authentication portion. As the block B 614 is generated the block is hashed 616 into the previous blockchain 604 resulting in an updated blockchain which is distributed among the respective user devices 300 of the various parties. In turn, the party C 634 may generate block C 618 in their transaction processing which is subsequently hashed 620 into the blockchain 604 which again results in an updated blockchain that is distributed among the respective user devices 300 of the various parties in the insurance claims transaction processing. Accordingly, similar to the parties A, B, and C, party D 636 and party E 638 generate block D 622 and block 626, respectively, that are hashed (i.e., hash 624 and hash 628) into the blockchain 604 which results in a further updated blockchain that is distributed to the respective use devices 300 of the various engaged parties. Importantly, in accordance with the disclosed embodiments, the transactions in each step are executed employing at least one smart contract and are stored by the corresponding user device into at least one blockchain utilized and managed by a blockchain-based insurance claims transaction system; the at least one blockchain is updated at each step by the corresponding user device; and the at least one blockchain is stored on each of the corresponding user devices.

As noted above, in some embodiments the method or methods described above may be executed or carried out by a computing system including a tangible computer-readable storage medium, also described herein as a storage machine, that holds machine-readable instructions executable by a logic machine (i.e., a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Thus, the steps of the disclosed method (see, e.g., FIGS. 7-8) and the associated discussion herein above can be defined by the computer program instructions stored in a memory and/or data storage device and controlled by a processor executing the computer program instructions. Accordingly, by executing the computer program instructions, the processor executes an algorithm defined by the disclosed method. For example, the computer program instructions can be implemented as computer executable code programmed by one skilled in the art to perform the illustrative operations defined by the disclosed methods. Further, it will be appreciated that any flowcharts, flow diagrams, state transition diagrams, pseudo code, program code and the like represent various processes which may be substantially represented in computer readable medium and so executed by a computer, machine, or processor, whether or not such computer, machine or processor is explicitly shown. One skilled in the art will recognize that an implementation of an actual computer or computer system may have other structures and may contain other components as well, and that a high-level representation of some of the components of such a computer is for illustrative purposes.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

1. A blockchain-based insurance claim transaction processing method, the method comprising:
receiving, from an insured party using a first device associated with the insured party and communicating via an insurance cloud network configured in accordance with an insurance cloud network architecture, a notice of claim on a second user device associated with an insurance provider and communicating via the insurance cloud network configured in accordance with the insurance cloud network architecture;
opening, using the second user device associated with the insurance provider, a new electronic claim record specific to the notice of claim received;
populating, using the second user device associated with the insurance provider, the electronic claim record opened with information from at least one insurance policy applicable to the notice of claim received;
assigning, using the second user device associated with the insurance provider, the electronic claim record populated to an insurance claims examiner;
issuing, using the second user device associated with the insurance provider, at least a claim acknowledgement letter to the insured party acknowledging the notice of claim received;
receiving, by the second user device associated with the insurance provider, at least one report generated by the insurance claims examiner, using a third user device associated with the insurance claims examiner and communicating via the insurance cloud network configured in accordance with the insurance cloud network architecture, containing a recommended resolution to the notice of claim received;
reviewing, using the second user device associated with the insurance provider, the at least one report received;
approving, using the second user device associated with the insurance provider, the recommended resolution to the notice of claim received;
creating, using the second user device associated with the insurance provider and at least the recommended solution approved, a final approved insurance claim resolution statement;
initiating, using the second user device associated with the insurance provider, at least one digital currency payment, based on the final approved insurance claim resolution statement created, to at least one digital wallet associated with the insured party; and
wherein (i) transactions in the blockchain-based insurance claim transactions processing in each step are executed employing at least one smart contract and are stored by the user device associated with the insured party, the insurance provider and the insurance claims examiner, respectively, into at least one blockchain utilized and managed by a blockchain-based insurance claims transaction system, and the insured party, the insurance provider and the insurance claims examiner each represent a particular party of a plurality of parties involved with the notice of claim received and perform a specific function related to a resolution thereof; (ii) the at least one blockchain is updated at each step by the user device associated with the insured party, the insurance provider and the insurance claims examiner, respectively; and (iii) the at least one blockchain is stored on each of the user devices associated with the insured party, the insurance provider and the insurance claims examiner, respectively.

2. The blockchain-based insurance claim processing method of claim 1, the method further comprising:
receiving, by the second user device associated with the insurance provider, at least one invoice generated by at least one third-party expert using a fourth user device associated with the at least one third-party expert and communicating via the insurance cloud network configured in accordance with the insurance cloud network architecture.

3. The blockchain-based insurance claim processing method of claim 2, wherein the method further comprises:
reviewing, using the second user device associated with the insurance provider, the at least one invoice received and issuing an invoice payment recommendation;
approving, using the second user device associated with the insurance provider, the invoice payment recommendation; and
initiating, using the second user device associated with the insurance provider, at least one other digital currency payment, based on the invoice payment recommendation approved, to at least one digital wallet associated with the at least one third-party expert.

4. The blockchain-based insurance claim processing method of claim 2, wherein the method further comprises:
reviewing, using the third user device associated with an insurance claims examiner, the at least one invoice received and issuing an invoice payment recommendation; and
rejecting, using the third user device associated with the insurance claim examiner, the at least one invoice received based on the invoice payment recommendation reviewed.

5. The blockchain-based insurance claim processing method of claim 1, wherein the method further comprises:
receiving, by the first user device associated with the insured party, the at least one digital currency payment to the at least one digital wallet associated with the insured party.

6. The blockchain-based insurance claim processing method of claim 3, wherein the method further comprises:
receiving, by the fourth user device associated with the third-party expert, the at least one other digital currency payment to the at least one digital wallet associated with the third-party expert.

7. The blockchain-based insurance claim processing method of claim 1, wherein the insurance provider is a Delegated Authorized Party, wherein the Delegated Authorized Party is an entity acting on behalf of the insurance provider with delegated authority therefrom.

8. The blockchain-based insurance claim processing method of claim 1 wherein the method further comprises:
performing a sanction check to verify an identity of the insured party prior to the initiating the at least one cryptocurrency payment.

9. The blockchain-based insurance claim processing method of claim 1, wherein the method further comprises:
receiving, by the second user device associated with the insurance provider, at least one invoice generated by at least one third-party expert using a fourth user device associated the at least one third-party expert and communicating via the insurance cloud network configured in accordance with the insurance cloud network architecture;
reviewing, using the second user device associated with the insurance provider, the at least one invoice received and issuing an invoice payment recommendation; and
adjusting, using the second user device associated with the insurance provider, the at least one invoice received based on the invoice payment recommendation issued.

10. The blockchain-based insurance claim processing method of claim 9, wherein the adjusting of the least one invoice received lowers a payment stipulated by the at least one invoice received.

11. The blockchain-based insurance claim processing method of claim 1, wherein the at least one digital currency payment is one of a cryptocurrency, a virtual currency, a central bank digital currency (CBDC), and a digital currency electronic payment (DCEP).

12. The blockchain-based insurance claim processing method of claim 1, wherein at least one of the first user device and the second user device is a smartphone.

13. The blockchain-based insurance claim processing method of claim 1, wherein the method further comprises:
recording, using the second user device associated with the insurance provider, one or more notes from the at least one report received.

14. The blockchain-based insurance claim processing method of claim 1, wherein the method further comprises:
initially rejecting, using the second user device associated with the insurance provider, the notice of claim received based on the recommended resolution to the notice of claim received.

15. A blockchain-based insurance claim transaction processing method, the method comprising:
receiving, from an insured party using a first device associated with the insured party and communicating via an insurance cloud network configured in accordance with an insurance cloud network architecture, a notice of claim on a second user device associated with an insurance provider and communicating via the insurance cloud network configured in accordance with the insurance cloud network architecture;
opening, using the second user device associated with the insurance provider, a new electronic claim record specific to the notice of claim received;
populating, using the second user device associated with the insurance provider, the electronic claim record opened with information from at least one insurance policy applicable to the notice of claim received;
assigning, using the second user device associated with the insurance provider, the electronic claim record populated to an insurance claim adjuster;
issuing, using the second user device associated with the insurance provider, at least a claim acknowledgement letter to the insured party acknowledging the notice of claim received;
generating by the insurance claims adjuster, using the second user device associated with the insurance provider, at least one reported containing a recommended resolution to the notice of claim received,
receiving, by the second user device associated with the insurance provider, the at least one report generated containing a recommended resolution to the notice of claim received;
approving, using the second user device associated with the insurance provider, the recommended resolution to the notice of claim received;
receiving, by the second user device associated with the insurance provider, at least one invoice generated by at least one third-party expert using a third user device associated with the at least one third-party expert and communicating via the insurance cloud network configured in accordance with the insurance cloud network architecture;
creating, using the second user device associated with the insurance provider and the recommend resolution to the notice of claim approved, a final approved insurance claim resolution statement;
initiating, using the second user device associated with the insurance provider, at least one digital currency payment, based on the final approved insurance claim resolution statement created, to at least one digital wallet associated with the insured party;
receiving, by the first user device associated with the insured party, the at least one digital currency payment to the at least one digital wallet associated with the insured party; and
wherein (i) transactions in each step in the blockchain-based insurance claim transactions processing are executed employing at least one smart contract and are stored by the user device associated with the insured party, the insurance provider and the at least one third-party expert, respectively, into at least one blockchain utilized and managed by a blockchain-based insurance claims transaction system, and the insured party, the insurance provider, the insurance claims adjuster and the third-party expert each represent a particular party of a plurality of parties involved with the notice of claim received and perform a specific function related to a resolution thereof; (ii) the at least one blockchain is updated at each step by the user device associated with the insured party, the insurance provider and the at least one third-party expert, respectively; and (iii) the at least one blockchain is stored on each of the user devices associated with the insured party, the insurance provider and the at least one third-party expert, respectively.

16. The blockchain-based insurance claim processing method of claim 15, wherein the method further comprises:
reviewing, using second user device associated with the insurance provider, the at least one invoice received and issuing an invoice payment recommendation;
approving, using the second user device associated with the insurance provider, the invoice payment recommendation issued; and
initiating, using the second user device associated with the insurance provider, at least one other digital currency payment, based on the invoice payment recommendation approved, to at least one digital wallet associated with the third-party expert.

17. The blockchain-based insurance claim processing method of claim 15, wherein the at least one digital currency payment is one of a cryptocurrency, a virtual currency, a central bank digital currency (CBDC), and a digital currency electronic payment (DCEP)

18. The blockchain-based insurance claim processing method of claim 15, wherein the method further comprises:
initially rejecting, using the second user device associated with the insurance provider, the notice of claim received.

19. The blockchain-based insurance claim processing method of claim 15, wherein the method further comprises:
reviewing, using a fourth user device associated with an insurance claims examiner and communicating via the insurance cloud network configured in accordance with the insurance cloud network architecture, the at least one report received.

20. A blockchain-based insurance claim transaction processing method, the method comprising:
receiving, from an insured party using a first device associated with the insured party and communicating via an insurance cloud network configured in accordance with an insurance cloud network architecture, a notice of claim on a second user device associated with an insurance provider, and communicating via the insurance cloud network configured in accordance with the insurance cloud network architecture and wherein the insurance provider is one of an insurance company, an insurance syndicate, an insurance carrier, an insurance provider, an insurance underwriter, a Lloyds Syndicate, a Managing General Agent (MGA), a Coverholder, a Delegated Authorized Party, an independent insurance adjusting company, a self-insured retention, and a third-party administrator;
opening, using the second user device associated with the insurance provider, a new electronic claim record specific to the notice of claim received;
populating, using the second user device associated with the insurance provider, the electronic claim record opened with information from at least one insurance policy applicable to the notice of claim received;
assigning, using the second user device associated with the insurance provider, the electronic claim record populated to an insurance claims examiner and an insurance claim adjuster, respectively;
issuing, using a third user device associated with the insurance claims adjuster and communicating via the insurance cloud network configured in accordance with the insurance cloud network architecture, at least a claim acknowledgement letter to the insured party acknowledging the notice of claim received;
generating, using the third user device associated with the insurance claims adjuster, at least one reported containing a recommended resolution to the notice of claim received;
receiving, by a fourth user device associated with the insurance claims examiner and communicating via the insurance cloud network configured in accordance with the insurance cloud network architecture, the at least one report generated containing a recommended resolution to the notice of claim received;
reviewing, using the fourth user device associated with the insurance claims examiner, the at least one report received containing a recommended resolution to the notice of claim received;
approving, using the fourth user device associated with the insurance claims examiner, the recommended resolution to the notice of claim received;
creating, using the second user device associated with the insurance provider and the recommended resolution approved, a final approved insurance claim resolution statement;
initiating, using the second user device associated with the insurance provider, at least one digital currency payment, based on the final approved insurance claim resolution statement created, to at least one digital wallet associated with the insured party, wherein the at least one digital currency payment is one of a cryptocurrency, a virtual currency, a central bank digital currency (CBDC), and a digital currency electronic payment (DCEP);
receiving, by the first user device associated with the insured party, the at least one digital currency payment to the at least one digital wallet associated with the insured party;
receiving, by the second user device associated with the insurance provider, at least one invoice generated by at least one third-party expert using a fifth user device associated with the at least one third-party expert and communicating via the insurance cloud network configured in accordance with the insurance cloud network architecture;
reviewing, using the fourth user device associated with the insurance claims examiner, the at least one invoice received and issuing an invoice payment recommendation;
approving, using the second user device associated with the insurance provider, the invoice payment recommendation issued;
initiating, using the second user device associated with the insurance provider, at least one other digital currency payment, based on the invoice payment recommendation approved, to at least one digital wallet associated with the at least one third-party expert;
receiving, using the fifth user device associated with the at least one third-party expert, the at least one other digital currency payment to the at least one digital wallet associated with the at least one third-party expert, and wherein the at least one other digital currency payment is one of a cryptocurrency, a virtual currency, a central bank digital currency (CBDC), and a digital currency electronic payment (DCEP); and
wherein (i) transactions in each step in the blockchain-based insurance claim transactions processing are executed employing at least one smart contract and are stored by the user device associated with the insured party, the insurance provider, the insurance claims adjuster, the insurance claims examiner, and the at least one third-party expert, respectively, into at least one blockchain utilized and managed by a blockchain-based insurance claims transaction system; (ii) the at least one blockchain is updated at each step by the user device associated with the insured party, the insurance provider, the insurance claims adjuster, the insurance claims examiner, and the at least one third-party expert, respectively, and the insured party, the insurance provider, the insurance claims adjuster, the insurance claims examiner, and the at least one third-party expert each represent a particular party of a plurality of parties involved with the notice of claim received and perform a specific function related to a resolution thereof; and (iii) the at least one blockchain is stored on each of the user devices associated with the insured party, the insurance provider, the insurance claims adjuster, the insurance claims examiner, and the at least one third-party expert, respectively.
